(19) United States
(12) Patent Application Publication
(10) Pub. No.: US 2015/0085759 A1
(43) Pub. Date: Mar. 26, 2015

(54) SELECTING BEARERS FOR UPLINK PACKET TRANSMISSIONS

(71) Applicant: Broadcom Corporation, Irvine, CA (US)

(72) Inventors: Rambabu Gajula, Bangalore (IN); Arzad Kherani, Bangalore (IN)

(73) Assignee: Broadcom Corporation, Irvine, CA (US)

(21) Appl. No.: 14/038,604

(22) Filed: Sep. 26, 2013

Related U.S. Application Data
(60) Provisional application No. 61/881,859, filed on Sep. 24, 2013.

(51) Int. Cl. H04W 72/04

(52) U.S. Cl. CPC H04W 72/0453
USPC 370/329

(57) ABSTRACT

Techniques are described for selecting bearers for uplink data packet transmissions. For instance, bearers may be selected using communication device-side techniques. In one example, a bearer may be selected based on a determination that other bearer(s) are not configured to support uplink data packet transmissions. In another example, a bearer may be selected irrespective of traffic flow template rules set forth by network(s) to which a communication device is connected. In yet another example, a single, default bearer that is linked to a network access point may be selected for transmission of uplink data packets that are associated with traffic flow template rules corresponding to non-default bearers. In still another example, a bearer may be selected based on its quality-of-service class identifier (QCI) value if the QCI value indicates that the bearer is configured to support uplink data packet transmissions.

### CROSS-REFERENCE TO RELATED APPLICATION(S)

This application claims the benefit of U.S. Provisional Patent Application No. 61/881,859, entitled “Selecting Bearers for Uplink Packet Transmissions,” filed Sep. 24, 2013, which is hereby incorporated herein by reference in its entirety and made part of this application for all purposes.

### BACKGROUND

1. Technical Field

The subject matter described herein relates to the selection of bearers for uplink packet transmissions.

2. Background Art

In communication systems and networks, uplink data packets (also called “uplink packets” herein) are data packets transmitted on an “uplink” connection from a communication device (e.g., a user equipment device (“UE”) such as a smart phone). The “uplink” connection is so named because data packets travel “upstream” from a user's communication device to devices in the communication network. For instance, communication devices may transmit uplink data packets to base station(s) (e.g., an “E-UTRAN Node B,” (a.k.a. Evolved Node B, eNodeB, or eNB)) and to one or more network devices (e.g., network gateways and access points) within a communication system.

An Evolved Packet System (“EPS”) is a 3rd Generation Partnership Project (“3GPP”) telecommunication system with an architecture designed for the Long-Term Evolution (“LTE”) communication standard. EPS is a connection-based standard in which a bearer connection (e.g., a radio bearer mapped to an EPS bearer) is made between two devices associated with a telecommunication system, such as a communication device and a base station, a gateway, and/or other network service components. Uplink data packets may be transmitted from a communication device on one or more of the bearer connections. A radio bearer is a communication device-side transmission link that is mapped to an EPS bearer (i.e., a base station-side or network-side transmission link). A communication device may have one or more radio bearers assigned to transmit one or more kinds of uplink packets. EPS bearers are configured and assigned by their associated base station, and radio bearer to EPS bearer mapping configurations are typically controlled by the base station. A communication device typically sends uplink packets according to packet classifications based on the Bearer Traffic Flow Template Rules generated by the network and configured by the base station (e.g., during Add/Modification time for EPS bearers by the base station). However, inefficiencies may result due to classifications based on the Bearer Traffic Flow Template Rules.

For instance, under certain traffic flow template (“TFT”) configurations, the communication device may be unable to send uplink packets, and the communication device cannot re-negotiate the configuration with the base station and/or the network. Further, existing 3GPP specifications are not clear about handling such situations.

### BRIEF DESCRIPTION OF THE DRAWINGS/FIGURES

The accompanying drawings, which are incorporated herein and form part of the specification, illustrate embodiments of the disclosed technologies and, together with the description, further serve to explain the principals involved and to enable a person skilled in the relevant art(s) to make and use the disclosed technologies.

FIG. 1 is a diagram of a telecommunication system, according to an exemplary embodiment.

FIG. 2 is a block diagram of a portion of a telecommunication system shown in FIG. 1, according to an exemplary embodiment.

FIG. 3 is a block diagram of an example implementation of a communication device shown in FIG. 1, according to an exemplary embodiment.

FIGS. 4-6 are flowcharts of example methods for selecting bearers for uplink data packet transmission, according to exemplary embodiments.

FIG. 7 is a block diagram of another example implementation of a communication device shown in FIG. 1, according to an exemplary embodiment.

FIG. 8 is a block diagram of a computing device, according to an exemplary embodiment.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Introduction

The following detailed description refers to the accompanying drawings that illustrate example embodiments of the disclosed technologies. However, the scope of the disclosed technologies is not limited to these embodiments, but is instead defined by the appended claims. Thus, embodiments beyond those shown in the accompanying drawings, such as modified versions of the illustrated embodiments, may nevertheless be encompassed by the disclosed technologies.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Further, descriptive terms used herein such as “about,” “approximately,” and “substantially” have equivalent meanings and may be used interchangeably.

Still further, it should be noted that illustrated embodiments shown in the figures are not drawn to scale unless specifically noted in this description. That is, illustrated dimensions and angles as shown in the figures are for illustrative purposes and are not considered to be limiting.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous exemplary embodiments are described as follows. It is noted that any section/subsection headings provided herein are not intended to be limiting. Embodiments are described throughout this document, and any type of embodiment may be included under any section and/or subsection. Furthermore, disclosed embodiments may be combined with each other in any manner

### 2. Example Embodiments

The examples described herein may be adapted to various types of wireless communications systems, e.g., telecommunication systems, computing systems, communication devices, components thereof, and/or the like for selecting bearers for uplink packet transmissions. Uplink packets may comprise voice data and/or non-voice data, and as used herein, uplink packets (e.g., uplink data packets) may refer to voice data packets and/or non-voice data packets. Furthermore, additional structural and operational embodiments, including modifications and/or alterations, will become apparent to persons skilled in the relevant art(s) from the teachings herein.

As described above, inefficiencies may result due to the current classification schemes for uplink packets, and a proprietary communication device-side handling may be needed.

For instance, in embodiments, uplink packets may be classified according to one or more traffic flow template (“TFT”) rules (a.k.a. TFT filters) and then passed to an associated radio bearer. TFT rules specify which EPS bearer is to be used to transmit designated type(s) of packets. Under such an approach, packets may be dropped if a radio bearer that is mapped to the EPS bearer is not configured to carry uplink traffic. In one example, uplink data packets may be sent over a default EPS bearer as described herein. In another example, the TFT rules may be marked as “invalid,” and the uplink data packets may be reclassified. Further still, bearer connections may be reconfigured to support uplink data packets.

In embodiments, uplink data packet TFT rules may be applied at the communication device before determining the EPS bearer to be used. For instance, if an access point of a network (or a network gateway associated with an access point name (“APN”)) has a single EPS bearer configured for uplink traffic, irrespective of any TFT rule classifications, the uplink data packets may be sent using the single EPS bearer (e.g., which is configured for that APN).

In a further embodiment, uplink data packets coming from a voice data source (e.g., a Voice over LTE (“VoLTE”) source or a voice processor) may bypass TFT filter checks and may be sent directly on an available EPS bearer without classification. For instance, if EPS bearers are reconfigured (e.g., during Add, Modification, and/or Delete configuration times for EPS bearers performed by the base station), a learning algorithm can identify EPS bearers that are carrying voice traffic and send uplink data packets directly on an available EPS bearer that has a Quality of Service (“QoS”) Class Index (“QCI”) value that is equal to (or greater than or equal to) a designated value (or within a range of values) indicative of being voice-capable. If no EPS bearer has such a QCI value, the configured TFT rules may be applied. Similarly, according to embodiments, voice uplink data packets may be transmitted on an EPS bearer that is being used (or is known to have been used) to transmit voice packets irrespective of packet classifications based on TFT rules.

While the discussion herein may refer to communication devices (e.g., user equipment (“UE”), smart phones, cellular phones, computing devices such as, but not limited to, tablet computers, desktop computers, laptop computers, and the like) for purposes of illustration, it will be recognized that such discussion is not so limited and is also applicable to other types of devices that may communicate wirelessly or using wired connections.

For instance, methods, systems, devices, and apparatuses are provided for selecting bearers for uplink data packet transmission. In an example aspect, a method is disclosed. The method includes receiving a classification of an evolved packet system (EPS) bearer in accordance with a traffic flow template rule that is associated with the EPS bearer for uplink transmission of an uplink packet. The method also includes determining whether a radio bearer associated with the EPS bearer is configured to support uplink packet transmissions. The method further includes performing an action associated with enabling the uplink transmission of the uplink packet, based on determining that the radio bearer is not configured to support uplink packet transmissions.

In another example aspect, a method is disclosed. The method includes determining that uplink packet(s) are to be provided from a communication device to an access point. The method also includes determining that the access point is associated with a single bearer of a designated type. The single bearer is associated with traffic flow template rule(s). The method further includes transmitting the uplink packet(s) using the single bearer from the communication device to the access point irrespective of the traffic flow template rule(s) in response to determining that the access point is associated with the single bearer.

In yet another example aspect, a method is disclosed. The method includes determining whether an evolved packet system (EPS) bearer that has a quality-of-service class identifier (QCI) value that indicates that the EPS bearer is configured to support transmission of voice packets is available for transmission of uplink packet(s). The method also includes transmitting the uplink packet(s) using the EPS bearer having the QCI value without classifying the uplink packet(s) based on traffic flow template rule(s) if an EPS bearer having the QCI value is available for transmission of uplink packet(s). The method further includes classifying the uplink packet(s) based on traffic flow template rule(s) to determine an EPS bearer that is to be used for transmission of the uplink packet(s) if no EPS bearer having the QCI value is available for transmission of uplink packet(s).

Various example embodiments are described in the following subsections. Generally, embodiments may be directed in whole or in part to selecting bearers for uplink packet transmission. In particular, example communication systems are described, followed by example communication system device embodiments. Next, example embodiments for communication devices are described. Example operational embodiments are subsequently described, followed by further embodiments and advantages. Finally, processing device embodiments are described.

### 3. Example Communication System Embodiments

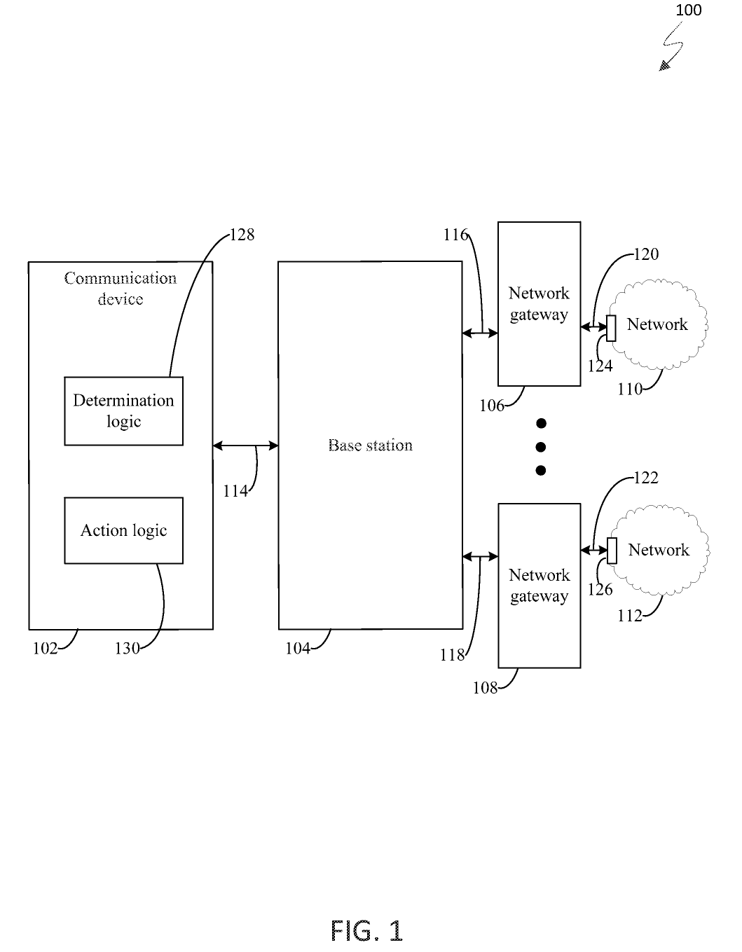

Communication systems may be configured in various ways, according to embodiments. One type of configuration is shown in FIG. 1. FIG. 1 illustrates a communication system 100. As illustrated, communication system 100 includes a communication device 102, a base station 104, a network gateway 106, a network gateway 108, a network 110, and a network 112 which are communicatively coupled through communication connections as shown and as described below.

For example, communication device 102 (e.g., a UE, a cellular phone, a smart phone, etc.) includes determination logic 128 configured to make one or more determinations and action logic 130 configured to take one or more actions, each of which is described in detail below. Communication device 102 communicates with base station 104 via communication connection 114. Communication connection 114 may include one or more uplink connections and one or more downlink connections. Base station 104 also communicates with one or more network gateways (e.g., network gateway 106 and/or network gateway 108) via one or more communication connections (e.g., a communication connection 116 and/or a communication connection 118) as shown. Network gateway 106 communicates with network 110 via a communication connection 120, and network gateway 108 communicates with network 112 via a communication connection 122. While uplink data transmissions (e.g., the transmitting of uplink data packets) are discussed in the embodiments herein, it should be noted that the communication device 102, base station 104, network gateway 106, network gateway 108, network 110, and network 112 may communicate bi-directionally through one or more of the communication connections described herein.

Each network gateway (e.g., network gateway 106 and/or network gateway 108) may correspond to an access point (i.e., a connection through which a communication device may communicate with network devices) of one or more networks (e.g., network 110 and/or network 112). As shown in FIG. 1, network 110 includes an access point 124, and network 112 includes an access point 126. Each access point may have an access point name (“APN”). For illustrative purposes, access point 124 may be referred to as APN1, and access point 126 may be referred to as APN2. While two networks (e.g., network 110 and/or network 112) are shown in FIG. 1, it is contemplated that in embodiments these networks may be part of the same overall network, and it is also contemplated that more or fewer network gateways and/or networks may be implemented in communication systems, according to embodiments.

When communication device 102 attempts to communicate with a device on a network (e.g., network 110 and/or network 112), communication device 102 transmits one or more uplink data packets to the device on the network through one or more of the communication connections shown in communication system 100 as described above. For instance, an uplink data packet transmitted by communication device 102 with a destination of network 110 is first transmitted to base station 104 via communication connection 114, then is transmitted from base station 104 to network gateway 106 via communication connection 116, and finally from network gateway 106 to network 110 via communication connection 120. Similarly, an uplink data packet transmitted by communication device 102 with a destination of network 112 is first transmitted to base station 104 via communication connection 114, then is transmitted from base station 104 to network gateway 108 via communication connection 118, and finally from network gateway 108 to network 112 via communication connection 122.

Communication system 100 of FIG. 1 and each of the components included therein or associated therewith may include functionality and connectivity beyond what is shown in FIG. 1, as would be apparent to persons skilled in relevant art(s). However, such additional functionality and connectivity are not shown in FIG. 1 for the sake of brevity.

### 4. Example Communication System Device Embodiments

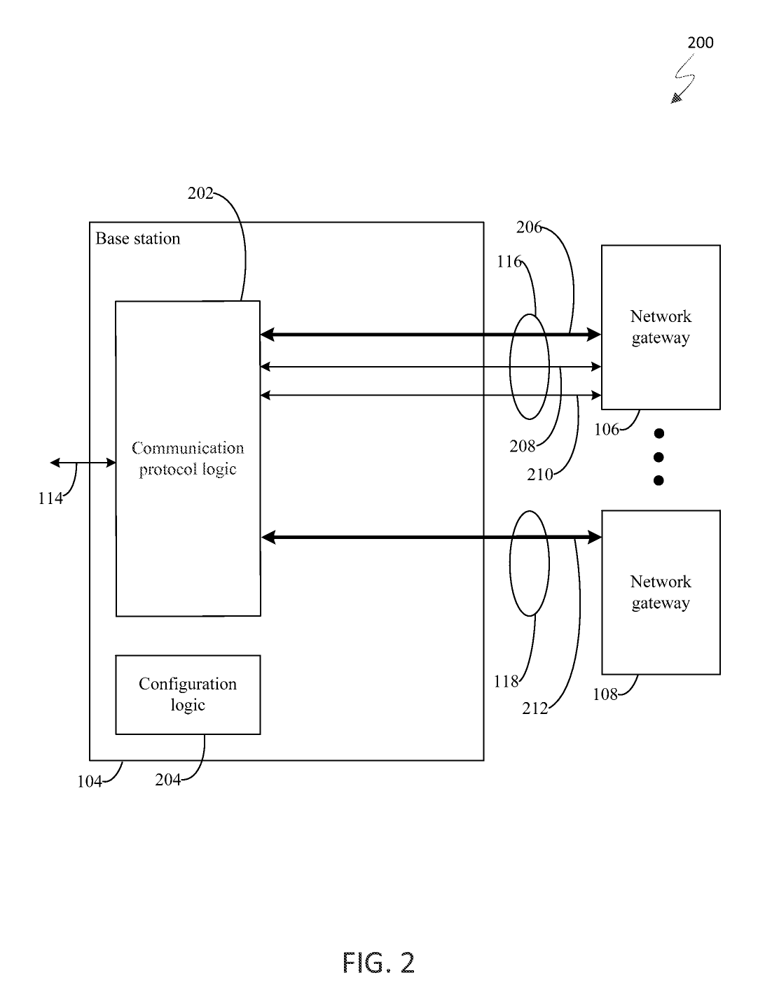

Turning to FIG. 2, exemplary communication system devices 200 are depicted, according to an embodiment. For instance, FIG. 2 shows base station 104, network gateway 106, and network gateway 108 of communication system 100 of FIG. 1. Base station 104, network gateway 106, and network gateway 108 are communicatively coupled via communication connection 116 and a communication connection 118 as shown, to support uplink data packet transmissions from a communication device via communication connection 114 according to exemplary embodiments, and may communicate via the EPS bearers shown in FIG. 2, as described below. In embodiments, uplink data packets may be transmitted from base station 104 to network gateways 106 and 108 as described herein.

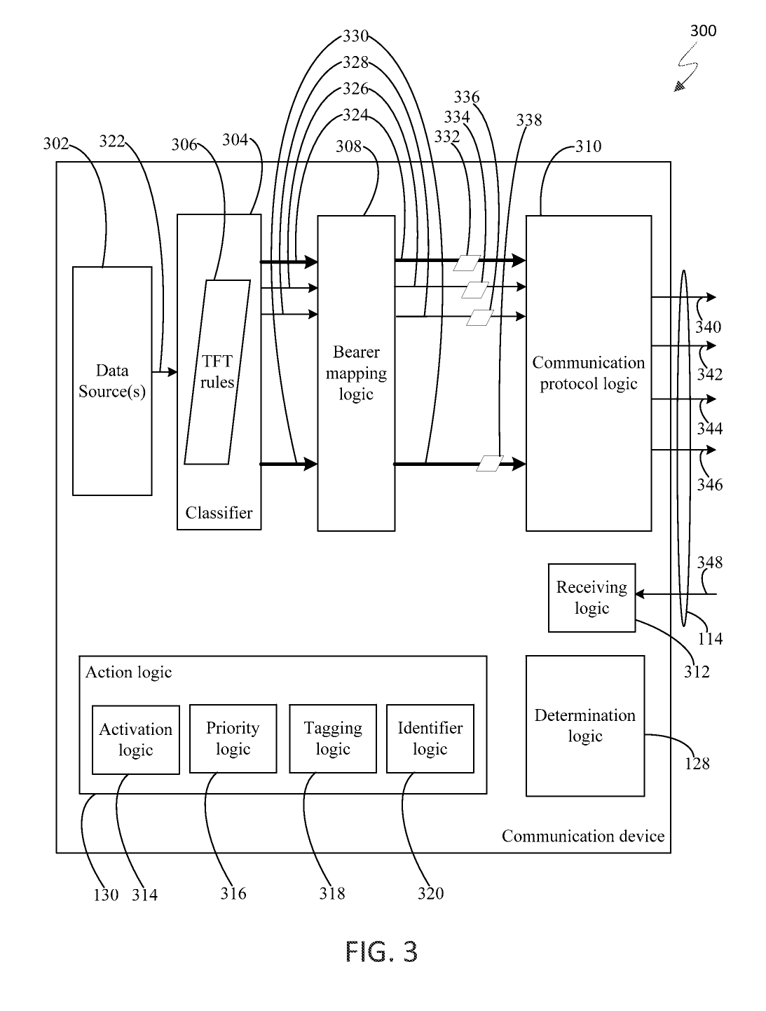

Base station 104 may include communication protocol logic 202 in accordance with one or more communication protocol standards contemplated herein (e.g., LTE and/or Voice over LTE (“VoLTE”)). Communication protocol logic 202 may receive uplink data packet transmissions from a communication device, e.g., communication device 102, as shown in FIGS. 1, 3 and/or 7, via communication connection 114, described in further detail with respect to FIG. 3 below. Received uplink data packets traverse communication protocol logic 202 and are sent to network gateway 106 and/or network gateway 108.

For example, communication connection 116 may include a first EPS bearer 206, a second EPS bearer 208, and a third EPS bearer 210 that communicatively couple base station 104 and network gateway 106. As shown in bold, first EPS bearer 206 is the default EPS bearer between base station 104 and network gateway 106. Communication connection 118 may comprise a fourth EPS bearer 212 that communicatively couples base station 104 and network gateway 108. As shown in bold, fourth EPS bearer 212 is the only EPS bearer, and therefore the default EPS bearer, between base station 104 and network gateway 108. In other words, when there is a single EPS bearer between devices such as base station 104 and a network gateway (e.g., network gateway 106 or network gateway 108), the single EPS bearer is referred to as the default EPS bearer, and in embodiments, each base station/network gateway communication coupling has at least one default EPS bearer.

Uplink data packets are received via radio bearers associated with a communication device, e.g., communication device 102, as shown in FIGS. 1, 3 and/or 7, as described herein, on communication connection 114. The received uplink data packets traverse communication protocol logic 202 and are provided to the destination network gateway using the appropriate EPS bearer that corresponds to the radio bearer used to transmit the uplink data packets. Corresponding EPS bearers may be designated using a mapping by bearer mapping logic, as noted above and as described in further detail below. In other words, bearer mapping logic may be configured to determine which radio bearer of a communication device corresponds to an EPS bearer. These bearer “mappings” may be referred to as bearer connections.

It should be noted that more or fewer EPS bearers may be present and/or configured in embodiments, and the EPS bearers shown in FIG. 2 are exemplary and illustrative in nature. Similarly, EPS bearers may be added, reconfigured, and/or deleted during the operation of communication system devices 200 as described below.

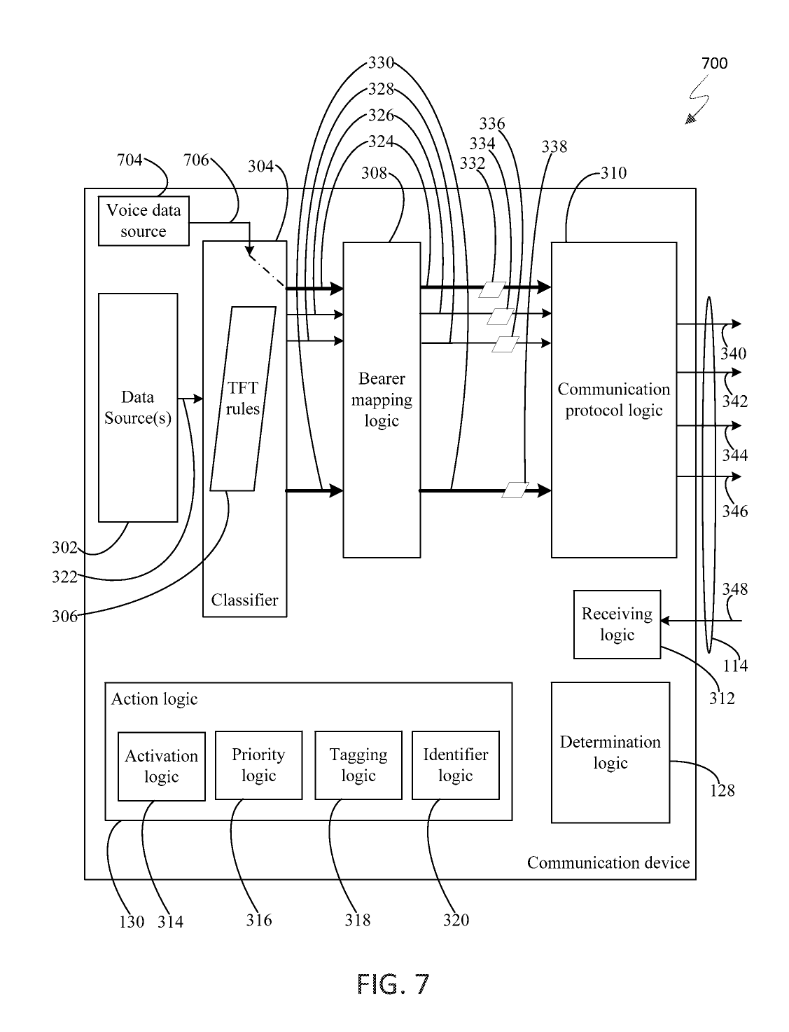

For instance, EPS bearers may be configured (e.g., added, deleted, activated, reconfigured, and/or otherwise configured) by configuration logic 204 of base station 104, as shown in FIG. 2, although it should be noted that configuration logic 204 may be located in other communication system devices not shown, in some embodiments. Configuration logic 204 may configure EPS bearers to support transmission of different types of packets such as, but without limitation, data packets (e.g., uplink data packets and/or uplink voice data packets), and configuration logic 204 may configure EPS bearers that have different QCIs. Configuration logic 204 may perform its functions in response to messages, commands and/or data received from one or more of network 110, network 112, network gateway 106, network gateway 108, as illustrated in FIG. 1, and/or other components of communication system 100 not shown, according to embodiments. Data associated with the configurations of EPS bearers may be transmitted to communication devices (e.g., communication device 102 shown in FIGS. 1 and, 3 and/or communication device 702 as shown in FIG. 7), via communication connection 114.

Communication system devices 200 of FIG. 2 (e.g., base station 104, network gateway 106, and/or network gateway 108) and each of the components included therein or associated therewith may include functionality and connectivity beyond what is shown in FIG. 2, as would be apparent to persons skilled in relevant art(s). However, such additional functionality is not shown in FIG. 2 for the sake of brevity.

### 5. Example Communication Device Embodiments

Communication devices may be configured in various ways according to embodiments. FIG. 3 shows a communication device 300, which is a block diagram of an example implementation of communication device 102 shown in FIG. 1, according to an exemplary embodiment. Communication device 300 includes determination logic 128, action logic 130, one or more data sources 302, a classifier 304, bearer mapping logic 308, communication protocol logic 310, and receiving logic 312. Classifier 304 stores and/or uses TFT rules 306. Action logic 130 may include one or more of activation logic 314, priority logic 316, tagging logic 318, and/or identifier logic 320. Communication device 300 may be configured to communicate (e.g., transmit data to and/or receive data from) one or more base stations such as base station 104 described herein via communication connection 114.

Data source(s) 302 provide uplink data packets to classifier 304 via connection 322. Classifier 304 provides the uplink data packets to bearer mapping logic 308 using one or more EPS bearers. A first EPS bearer 324, a second EPs bearer 326, a third EPS bearer 328, and a fourth EPS bearer 330 are shown for illustrative purposes and are not intended to be limiting. As shown, first EPS bearer 324, second EPs bearer 326, and third EPS bearer 328 correspond to network gateway 106 and a first access point and a first network (e.g., access point 106 and network 110 of FIG. 1). Fourth EPS bearer 330 corresponds to network gateway 108 and a second access point and a second network (e.g., access point 108 and network 112 of FIG. 1). As shown in bold, first EPS bearer 324 is the default EPS bearer associated with the first network gateway. Fourth EPS bearer 330 is the only EPS bearer associated with the second network gateway. Thus, fourth EPS bearer serves as the default EPS bearer for the second network gateway. As noted above with respect to FIG. 2, when there is a single EPS bearer associated with a network gateway, the single EPS bearer is referred to as the default EPS bearer for that network gateway. In some embodiments, each network gateway has at least one (e.g., a single) default EPS bearer.

The uplink data packets are provided from bearer mapping logic 308 to communication protocol logic 310 on the aforementioned EPS bearers, where each EPS bearer has a corresponding mapping described below. Communication protocol logic 310 transmits the uplink data packets to a base station via communication connection 114 which includes one or more radio bearers. Receiving logic 312 may receive messages, data, and/or commands (e.g., EPS bearer configuration messages and information) from a base station (e.g., base station 104) via communication connection 114.

Determination logic 128 and action logic 130 (along with any respective subcomponents) may be connected to one or more (e.g., any) other components of communication device 300 as described herein, but for illustrative clarity these connections are not shown. For example, activation logic 314, priority logic 316, tagging logic 318, and/or identifier logic 320 may provide messages, data, and/or commands to classifier 304. Determination logic 128 may receive data from and provide data and/or commands to data source(s) 302, classifier 304, and/or receiving logic 312. Other exemplary connections will be understood by one of skill in the relevant art(s) having the benefit of this disclosure.

Data source(s) 302 may be configured to provide uplink data packets including, but not limited to, voice data packets and non-voice data packets, for uplink transmission. Data source(s) 302 may include voice data source(s) (e.g., telephony applications and telephones) and/or non-voice data source (e.g., one or more processors and/or processing devices). Data source(s) 302 may provide data such as pictures, multi-media data, etc., and/or the like from applications running on communication device 300. Data source(s) 302 may provide data to classifier 304 in the form of data packets of various types as would be apparent to one of skill in the relevant art(s) having the benefit of this disclosure. Data packets from data source(s) 302 may include source identification information (e.g., source name, source type, source IP address, etc.), and may also include destination identification information (e.g., destination name, destination type, destination IP address, APN, etc.).

Classifier 304 may be configured to classify uplink data packets that are received from data source(s) 302 according to TFT rules 306 that are configured by a base station (e.g., base station 104 of FIGS. 1 and 2). Generally, TFT rules 306 indicate which EPS bearer is to be used to transmit designated type(s) of uplink data packet(s). In embodiments, however, EPS bearers may be assigned for transmitting uplink data packets irrespective of TFT rules 306. Classifier 304 may be configured to provide classified uplink data packets to bearer mapping logic 308 on appropriate EPS bearers as described herein. For instance, an uplink data packet destined for an APN (e.g., APN 124 of FIG. 1) that is associated with a network gateway (e.g., network gateway 106 of FIG. 1) may be determined and/or identified by an IP address of the APN, which may be included in a packet header of the uplink data packet. The classification of an uplink data packet by classifier 304 may be used by bearer mapping logic 308 for mapping the radio bearer of communication device 300 to a corresponding EPS bearer that is configured by a base station, as is described below.

Classifier 304 is also configured to receive messages, commands, and/or data from determination logic 128, action logic 130, and/or one or more subcomponents of action logic 130. Based upon the received messages, commands, and/or data, classifier 304 may ignore, activate, de-activate, and/or re-activate one or more TFT rules 306. For example, classifier 304 may classify uplink data packets based on one or more traffic flow template rules to determine an EPS bearer that is to be used for transmission of the uplink data packets in response to receiving one or more messages, commands, and/or data from determination logic 128. In accordance with this example, classifier 304 may classify the uplink data packets based on the one or more messages, commands, and/or data indicating that there are no EPS bearers having a designated QCI value that are available for transmission of uplink data packet(s). The designated QCI value may indicate that the EPS bearer is configured to support transmission of voice packets. If one EPS bearer having the designated QCI value is available, classifier 304 may select the EPS bearer having the designated QCI value. If multiple EPS bearers having the designated QCI value are available, classifier 304 may select one of those EPS bearers (e.g., randomly, semi-randomly, or based on one or more specified criteria).

Bearer mapping logic 308 may be configured to map a given EPS bearer to a corresponding radio bearer for transmission of uplink data packets to a base station based at least on the classification of the uplink data packets by classifier 304. Each of the EPS bearers that connect bearer mapping logic 308 to communication protocol logic 310 may have a corresponding mapping. For example, a first mapping 332 corresponds to first EPS bearer 324, a second mapping 334 corresponds to second EPS bearer 326, a third mapping 336 corresponds to third EPS bearer 328, and a fourth mapping 338 corresponds to fourth EPS bearer 330, as shown in FIG. 3. Each described mapping indicates that a given EPS bearer is mapped to a radio bearer.

Communication protocol logic 310 may include logic to perform functions in accordance with one or more communication protocols including but not limited to LTE, VoLTE, etc. For example, uplink data packets received from bearer mapping logic 308 on mapped EPS bearers as described above, may traverse communication protocol logic 310 according to an implemented protocol and may be transmitted from communication device 300 using radio bearers corresponding to the mapped EPS bearers by communication protocol logic 310. In embodiments, communication protocol logic is configured to initiate an attempt to transmit an uplink data packet using a radio bearer of communication device 300 based on the uplink data packet being classified by classifier 304 according to a TFT rule. A first radio bearer 340 corresponds to mapped EPS bearer 324, a second radio bearer 342 corresponds to mapped EPS bearer 326, a third radio bearer 344 corresponds to mapped EPS bearer 328, and a fourth radio bearer 346 corresponds to mapped EPS bearer 330.

Communication protocol logic 310 may be configured to transmit uplink data packets on a single bearer associated with an access point of a network irrespective of one or more TFT rules associated with the uplink data packet. For example, if EPS bearer 330 is the only EPS bearer associated with access point 126 for network 112 (shown in FIG. 1) as described above for illustrative purposes, communication protocol logic 310 may transmit uplink data packets using EPS bearer 330 (and corresponding radio bearer 346) even if TFT rules 306 that are applied to the uplink data packets specify that other bearers are to be used or if no TFT rules 306 have been applied to the uplink data packets.

FIG. 3 shows four radio bearers (i.e., first radio bearer 340, second radio bearer 342, third radio bearer 344, and fourth radio bearer 346) configured for uplink data packet transmission for illustrative purposes and is not intended to be limiting. In embodiments, more or fewer radio bearers may be configured for uplink data packet transmission. For example, second EPS bearer 326 may be mapped to second radio bearer 342, but second radio bearer 342 may be configured as “downlink only.” Hence, uplink transmissions using second EPS bearer 326 as mapped to second radio bearer 342 may fail when attempted.

Receiving logic 312 is configured to receive communications (e.g., messages, data, and/or commands such as EPS bearer configuration messages and information) from a base station (e.g., base station 104) via communication connection 114. As shown, communication connection 114 includes a downlink connection 348 which may be used to receive the messages, data, and/or commands from the base station. Receiving logic 312 is configured to receive one or more classifications of an EPS bearer in accordance with one or more TFT rules that are associated with the EPS bearer to be used for uplink transmission of uplink data packets. Receiving logic 312 is also configured to receive communications that indicate radio bearers have been reconfigured.

While shown separately for illustration, receiving logic 312 may reside in any one or more other components of communication device 300. Receiving logic 312 may be communicatively coupled to one or more (i.e., any) of the components of communication device 102, but such connections are omitted for illustrative clarity. For example, each of classifier 304, bearer mapping logic 308, determination logic 128, and/or action logic 130 may receive messages, data, and/or commands via receiving logic 312. While a single downlink connection 348 is shown, it will be recognized that additional downlink connections from the base station, and/or from additional base stations, may be present.

Determination logic 128 is configured to perform numerous determinations in the embodiments described herein. Determination logic 128 may be implemented as a processor, a digital signal processor (DSP), an integrated circuit (IC), an application specific integrated circuit (ASIC), a programmable logic device (e.g., a field programmable gate array (FPGA)), combinatorial logic, and/or the like (or a portion thereof) according to embodiments. Determination logic 128 is configured to determine that a radio bearer has been configured or re-configured to support uplink data packet transmissions. Such determinations may be based on messages, commands, and/or data received by determination logic 128 from one or more devices and/or components described herein (e.g., configuration logic 204 of FIG. 2). Determination logic 128 is also configured to provide messages, commands, and/or data to action logic 130 (e.g., any one or more subcomponents thereof), classifier 304, bearer mapping logic 308, and/or communication protocol logic 310 to prompt these components (or any subcomponents thereof) to perform actions according to the example embodiments described herein. For instance, if an attempt to transmit an uplink data packet fails at communication protocol logic 310, determination logic 128 may determine that the radio bearer used to attempt the transmission does not support uplink transmissions based on this failure. In response, determination logic 128 may send a message, command, and/or data indicating that the failure has occurred; determination logic 128 may provide the radio bearer configuration to one or more components (or subcomponents thereof) of communication device 300.

In an example embodiment, determination logic 128 is configured to determine that at least one uplink data packet is to be provided from communication device 300 to an access point (e.g., access point 126 of FIG. 1) and that that the access point is associated with a single bearer of a designated type (e.g., EPS bearer 330 or radio bearer 346 of FIG. 3). In accordance with this embodiment, the single bearer is associated with one or more traffic flow template rules (e.g., TFT rules 306). For instance, determination logic 128 may make such determinations based on one or more messages, commands, and/or data, such as EPS bearer configuration and/or re-configuration messages that are received from a base station (e.g., base station 104) by receiving logic 312 and provided to determination logic 128. Determination logic 128 may also make such determinations based on one or more failed attempts by communication protocol logic 310 to transmit uplink data packets.

In accordance with this embodiment, determination logic 128 may provide one or more messages, commands, and/or data to classifier 304 that prompt classifier 304 to classify uplink data packet(s) for transmission using the single EPS bearer 330 (i.e., the default EPS bearer) associated with an access point. As bearer mapping logic 308 has mapped the single EPS bearer to a corresponding radio bearer, the uplink data packet(s) may then be transmitted from communication device 300 to the access point (e.g., access point 126) using the corresponding radio bearer (e.g., radio bearer 346). In this manner, the uplink data packet(s) are transmitted using the single bearer from the communication device 300 to the access point irrespective of the one or more traffic flow template rules (e.g., TFT rules 306) in response to determining that the access point is associated with the single bearer.

In an aspect of this embodiment, determination logic 128 provides one or more messages, commands, and/or data to classifier 304 that prompt classifier 304 to use the single EPS bearer 330 (i.e., the default EPS bearer) associated with the access point without performing a classification on the uplink data packet(s). Again, as bearer mapping logic 308 has mapped the single EPS bearer to a corresponding radio bearer, the uplink data packet(s) may then be transmitted from communication device 300 to the access point (e.g., access point 126) using the corresponding radio bearer (e.g., radio bearer 346). In this manner, the uplink data packet(s) are transmitted using the single bearer from the communication device 300 to the access point without performing a classification of the uplink data packet using the one or more traffic flow template rules in response to determining that the access point is associated with the single bearer.

In another example embodiment, determination logic 128 is configured to determine whether uplink data packet(s) are respective voice packet(s) based on the uplink data packet(s) being received from a voice processor and/or the like, based on a source from which the uplink data packet(s) are received, and/or based on a destination to which at least one of the uplink data packet(s) is to be transmitted. Such a determination may be made by determination logic 128 by receiving information such as packet header(s) from data source(s) 302 and/or classifier 304.

In yet another example embodiment, determination logic 128 is configured to determine whether an EPS bearer that has a quality-of-service class identifier (QCI) value that indicates that the EPS bearer is configured to support transmission of voice packets is available for transmission of uplink data packet(s). For instance, determination logic 128 may determine whether the EPS bearer having the QCI value is available in response to determining that the uplink data packet(s) are respective voice packet(s). Determination logic 128 may make QCI value determinations based on one or more messages, commands, and/or data, such as EPS bearer configuration and/or re-configuration messages that are received from a base station (e.g., base station 104) by receiving logic 312 and provided to determination logic 128.

Based on a determination that the EPS bearer having the value is available, determination logic 128 may provide one or more messages, commands, and/or data to classifier 304 that prompt classifier 304 to select and use the EPS bearer having the QCI value without performing a classification on the uplink data packet(s) using TFT rules 306. Thus, the uplink data packet(s) may be transmitted by communication protocol logic 310 using the radio bearer that is mapped to the EPS bearer having the QCI value. If a plurality of EPS bearers having QCI values that indicate that the respective EPS bearers are configured to support transmission of voice packets are available, an EPS bearer having a QCI value that is greater than or equal to the QCI values of others of the plurality of EPS bearers may be selected. In some aspects, determination logic 128 may determine that an EPS bearer has the QCI value based on the EPS bearer having already been used to transmit one or more voice data packets.

Based on a determination that no EPS bearers having the value are available, determination logic 128 may provide one or more messages, commands, and/or data to classifier 304 that prompt classifier 304 to classify the uplink data packet(s) based on one or more TFT rules 306 to determine an EPS bearer that is to be used for transmission of the uplink data packet(s).

Action logic 130 is configured to perform numerous actions in the embodiments described herein. For example, action logic 130 (or any subcomponents thereof) may be configured to perform actions associated with enabling the uplink transmission of uplink data packet(s). In embodiments, the actions may be performed based on a determination that a radio bearer of communication device 300 is not configured to support uplink data packet transmissions, as described above. Action logic 130 may be implemented as a processor, a digital signal processor (DSP), an integrated circuit (IC), an application specific integrated circuit (ASIC), a programmable logic device (e.g., a field programmable gate array (FPGA)), combinatorial logic, and/or the like (or a portion thereof) according to embodiments. Action logic 130 may be implemented concurrently on a device as described herein with determination logic 128. Action logic 130 may include one or more subcomponents such as, but not limited to, activation logic 314, priority logic 316, tagging logic 318, identifier logic 320, and/or the like.

Activation logic 314 is configured to perform activation-related tasks for TFT rules according to embodiments. In one example embodiment, activation logic 314 is configured to activate one or more TFT rules that are associated with an EPS bearer in response to determining that a radio bearer has been reconfigured to support uplink data packet transmissions. For example, as noted above, the radio bearer initially may be configured as “downlink only” (i.e., to support downlink transmissions but not uplink transmissions). In accordance with this example, a base station (e.g., base station 104 of FIG. 1) may reconfigure the radio bearer and provide a message to communication device 102 at receiving logic 312 via downlink connection 348 that indicates the radio bearer has been reconfigured to support uplink data packet transmissions. Receiving logic 312 may provide the received message to determination logic 128. Determination logic 128 may determine from the message that the radio bearer now supports uplink data packet transmissions and may provide a message, command, and/or data to activation logic 314 which in turn provides a message command, and/or data to the appropriate component of communication device 300. In aspects, the message, command, and/or data from activation logic 314 may be provided to classifier 304, indicating that classifier 304 is to activate a TFT rule associated with the reconfigured radio bearer.

In another example embodiment, activation logic 314 is configured to de-activate one or more TFT rules based on one or more criteria. For example, if an attempt to transmit an uplink data packet using a radio bearer fails, the TFT rule associated with the radio bearer may be de-activated to prevent future failed transmissions and to allow other TFT rules or techniques described herein to be used. In aspects, a message, command, and/or data from activation logic 314 may be provided to classifier 304, indicating that classifier 304 is to de-activate the TFT rule associated with the radio bearer that corresponds to the failed transmission attempt.

In yet another example embodiment, activation logic 314 is configured to re-activate one or more TFT rules in response to determining that a reconfigured radio bearer is configured to support uplink data packet transmissions. As noted above, activation logic 314 may be configured to activate and de-activate TFT rules. A de-activated TFT rule may be re-activated in a similar manner as described above with respect to TFT rule activation in response to communication device 300 receiving a message regarding the re-configuration of the radio bearer.

Priority logic 316 is configured to perform priority-related tasks for TFT rules according to embodiments. In one example embodiment, priority logic 316 is configured to reduce the priority of a first subset of TFT rules relative to a second subset of the TFT rules. This allows the second subset of the TFT rules to take precedence in use for transmitting uplink data packets. As an example, priority logic 316 may receive a message, command, and/or data from determination logic 128 that indicates a radio bearer is not configured to support uplink data packet transmissions. For instance, if an attempt to transmit an uplink data packet fails, determination logic 128 may determine that the radio bearer does not support uplink transmissions, and a message, command, and/or data indicating the radio bearer configuration may be provided to priority logic 316. Priority logic 316 may then provide a message, command, and/or data to classifier 304 to lower the priority of the corresponding TFT rule used during the failed transmission attempt.

In another example embodiment, priority logic 316 is configured to increase the priority of a first subset of TFT rules relative to a second subset of the TFT rules based on one or more criteria. This allows the first subset of the TFT rules to take precedence in use for transmitting uplink data packets. As an example, if a radio bearer has been reconfigured by a base station, as described above, priority logic 316 may indicate to classifier 304 using a message, command, and/or data that the corresponding TFT rule used during the failed attempt may be increased in priority in response to the reconfiguration.

Tagging logic 318 is configured to perform tagging-related tasks for TFT rules according to embodiments. As an example, tagging logic 318 may receive a message, command, and/or data from determination logic 128 that indicates a radio bearer is not configured to support uplink data packet transmissions. For instance, if an attempt to transmit an uplink data packet fails, determination logic 128 may determine that the radio bearer does not support uplink transmissions, and a message, command, and/or data indicating the radio bearer configuration may be provided to tagging logic 318. Tagging logic 318 may then provide a message, command, and/or data to classifier 304 to tag the corresponding TFT rule used during the failed transmission attempt as invalid, thereby prompting classifier 304 to use a different classification scheme (i.e., uplink data packets may be re-classified by classifier 304 to use alternate EPS bearers).

Identifier logic 320 is configured to perform identity-related tasks for EPS bearers according to embodiments. For example, identifier logic 320 may identify one or more uplink data packets that are received from data source(s) 302 as including voice data. In accordance with this example, identifier logic 320 may make such an identification based on packet headers in the uplink data packets. Identifier logic 320 may receive uplink data packets and/or information pertaining thereto from data source(s) 302 and/or from classifier 304. If EPS bearers are configured or reconfigured (e.g., by a base station such as base station 104 of FIG. 1), a learning algorithm implemented by identifier logic 320 may be configured identify one or more EPS bearers carrying voice data packet uplink traffic. Identifier logic 320 may provide a message, command, and/or data to classifier 304 that indicates an uplink data packet includes voice data to prompt classifier 304 to classify the uplink data packet as corresponding to a designated EPS bearer as described herein.

It should be noted that the subcomponents of action logic 130 described herein may be used independently of each other or in conjunction with each other to perform the actions described herein.

Communication device 300 and each of the components and/or subcomponents included therein or associated therewith may include functionality and connectivity beyond what is shown in FIG. 3, as would be apparent to persons skilled in relevant art(s). However, such additional functionality is not shown in FIG. 3 for the sake of brevity.

FIG. 7 shows a communication device 700, which is a block diagram of another example implementation of communication device 102 shown in FIG. 1, according to an exemplary embodiment. Communication device 700 is configured in a similar manner to communication device 300 of FIG. 3. For instance, communication device 700 includes determination logic 128, action logic 130, one or more data sources 302, a classifier 304, bearer mapping logic 308, communication protocol logic 310, and receiving logic 312, which operate in the manner described above with respect to FIG. 3.

Communication device 700 differs from communication device 300 in that communication device 700 further includes a voice data source 704 (e.g., a VoLTE source, a voice processor, etc.) that provides voice data to be transmitted in uplink packets. Voice data source 704 is shown to be external to data source(s) 302 for illustrative purposes and is not intended to be limiting. It will be recognized that data source(s) 302 may include voice data source 704. Uplink data packets coming from voice data source 704 may bypass TFT rules 306, which are used by classifier 304 for purposes of classification, and may be sent directly on available EPS bearer(s) without such classification. For instance, if EPS bearer(s) are configured or reconfigured (e.g., by a base station such as base station 104 of FIG. 1), a learning algorithm implemented by identifier logic 320 may identify one or more EPS bearers carrying voice data packet uplink traffic. For example, determination logic 128 may determine one or more EPS bearers carrying voice data packet uplink traffic as described above. Uplink packets (e.g., voice data packets) may be transmitted directly on such an available EPS bearer and/or on an EPS bearer that has a QCI value that is equal to (or greater than or equal to) a designated value indicative of being voice-capable. If no EPS bearers have such a QCI value, the configured uplink packet TFT rules may be applied as described above with respect to FIG. 3.

Communication device 700 and each of the components included therein or associated therewith may include functionality and connectivity beyond what is shown in FIG. 7, as would be apparent to persons skilled in relevant art(s). However, such additional functionality is not shown in FIG. 7 for the sake of brevity.

Example operational embodiments are described in the next section.

### 6. Example Operational Embodiments

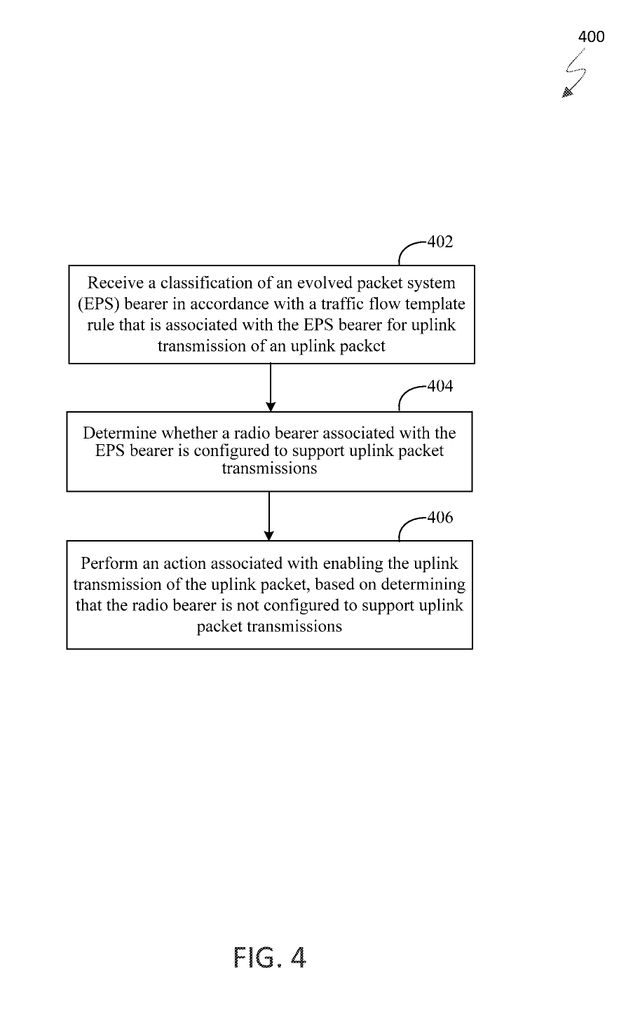

In this section, exemplary operational embodiments for selecting bearers for uplink packet transmission are described. The embodiments described herein may perform their functions in various ways. For instance, flowcharts 400, 500, and 600 of respective FIGS. 4, 5, and 6 provide example steps for selecting bearers for uplink data packet transmission, according to exemplary embodiments. It will be recognized that any number of steps of the described flowcharts may be performed by a communication device (e.g., communication device 102 of FIG. 1, communication device 300 of FIG. 3, and/or communication device 700 of FIG. 7), as described herein. For illustrative purposes, flowcharts 400, 500, and 600 are described with respect to the aforementioned communication devices. Other structural and operational embodiments will be apparent to persons skilled in the relevant art(s) based on the discussion regarding flowcharts 400, 500, and 600.

As shown in FIG. 4, the method of flowchart 400 begins with step 402. In step 402, a classification of an evolved packet system (EPS) bearer in accordance with a traffic flow template rule is received. The traffic flow template rule is associated with the EPS bearer for uplink transmission of an uplink packet. In an example implementation, receiving logic 312 receives the classification. For instance, receiving logic 312 may receive the classification from a base station (e.g., base station 104 of FIG. 1). In accordance with this implementation, receiving logic 312 may provide the received classification to classifier 304 and/or determination logic 128 for further processing.

In step 404, a determination is made whether a radio bearer associated with the EPS bearer is configured to support uplink packet transmissions. In an example implementation, determination logic 128 determines whether the radio bearer is configured to support uplink packet transmissions. For instance, determination logic 128 may make the determination based on information in the classification that is received at step 402 and/or based on a success or a failure of an attempted transmission of an uplink data packet from communication device 300.

In step 406, an action associated with enabling the uplink transmission of the uplink packet is performed, based on determining that the radio bearer is not configured to support uplink packet transmissions. In an example implementation, action logic 130 (e.g., one or more components thereof), determination logic 128, receiving logic 312, communication protocol logic 310, and/or one or more other components of communication device 300 performs the action.

In an example embodiment, step 406 includes transmitting the uplink packet to a base station and/or a network entity on a default bearer connection.

In another example embodiment, step 406 includes tagging the traffic flow rule as invalid, and/or reclassifying the uplink packet from the EPS bearer to an alternate EPS bearer and associating the uplink packet with an alternate radio bearer according to an alternate traffic flow template rule that is associated with the alternate EPS bearer.

In yet another example embodiment, step 406 includes receiving a communication that indicates that the radio bearer is reconfigured to provide a reconfigured radio bearer. In accordance with this embodiment, step 406 further includes determining that the reconfigured radio bearer is configured to support uplink packet transmissions in response to receiving the communication. In accordance with this embodiment, step 406 further includes activating a traffic flow template rule that is associated with the EPS bearer in response to determining that the reconfigured radio bearer is configured to support uplink packet transmissions.

In still another example embodiment, step 406 includes de-activating the traffic flow template rule. In accordance with this embodiment, step 406 further includes receiving a communication that indicates that the radio bearer is reconfigured to provide a reconfigured radio bearer. In accordance with this embodiment, step 406 further includes determining that the reconfigured radio bearer is configured to support uplink packet transmissions. In accordance with this embodiment, step 406 further includes re-activating the traffic flow template rule in response to determining that the reconfigured radio bearer is configured to support uplink packet transmissions.

In yet another example embodiment, step 406 includes reducing a priority of the traffic flow template rule. In accordance with this embodiment, step 406 further includes receiving a communication that indicates that the radio bearer is reconfigured to provide a reconfigured radio bearer. In accordance with this embodiment, step 406 further includes determining that the reconfigured radio bearer is configured to support uplink packet transmissions. In accordance with this embodiment, step 406 further includes increasing the priority of the traffic flow template rule in response to determining that the reconfigured radio bearer is configured to support uplink packet transmissions.

In some example embodiments, one or more steps 402, 404, and/or 406 of flowchart 400 may not be performed. Moreover, steps in addition to or in lieu of steps 402, 404, and/or 406 may be performed. Further, in some example embodiments, one or more of steps 402, 404, and/or 406 may be performed out of order, in an alternate sequence, or partially (or completely) concurrently with other steps.

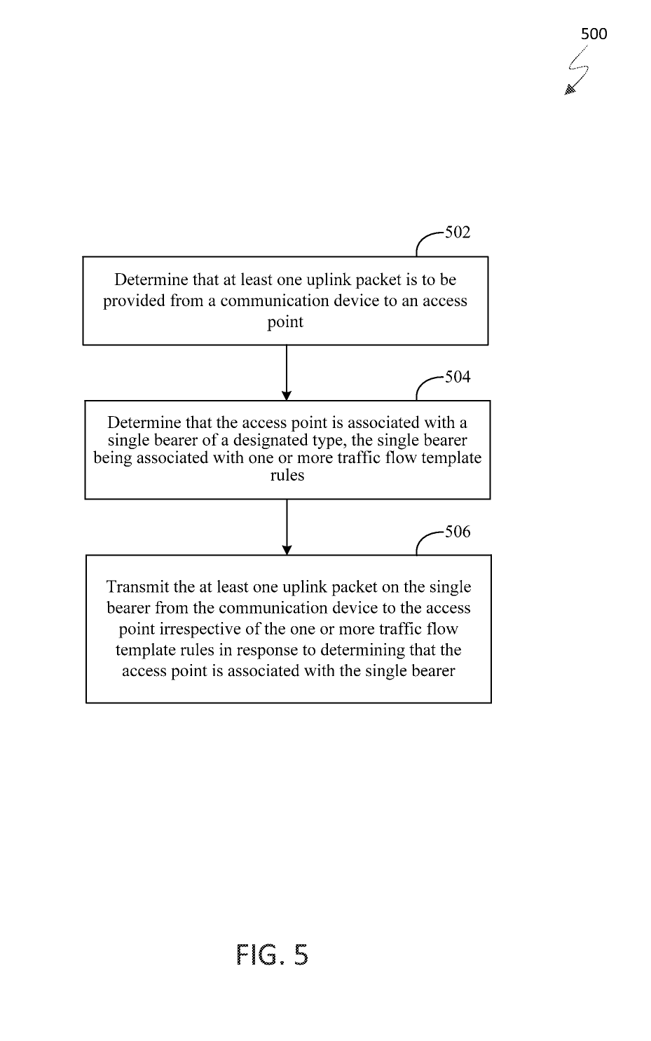

As shown in FIG. 5, the method of flowchart 500 begins with step 502. In step 502, a determination is made that at least one uplink packet is to be provided from a communication device to an access point. In an example implementation, determination logic 128 determines that at least one uplink packet is to be provided from communication device 300 to an access point (e.g., access point 124 and/or access point 126 of FIG. 1). For instance, determination logic 128 may make the determination based on information (e.g., a source IP address, a destination IP address, a packet type, etc.) in one or more uplink packet headers.

In step 504, a determination is made that the access point is associated with a single bearer of a designated type. The single bearer is associated with one or more traffic flow template rules. In an example implementation, determination logic 128 determines that the access point is associated with a single bearer of the designated type. For example, receiving logic 312 may receive one or more messages regarding EPS bearer configurations from a base station (e.g., base station 104 of FIG. 1). Such received message(s) may indicate that a single EPS bearer (e.g., EPS bearer 330) is configured between the access point, base station 104, and communication device 300. The single EPS bearer may be of a type that supports transmission of voice data packets, non-voice data packets, and/or other kinds of uplink packets. Accordingly, the single EPS bearer may be associated with one or more TFT rules 306 for the transmission of designated types of uplink packets.

In step 506, the at least one uplink packet is transmitted using the single bearer from the communication device to the access point irrespective of the one or more traffic flow template rules in response to determining that the access point is associated with the single bearer. In an example implementation, communication protocol logic 310 transmits the at least one packet using the single EPS bearer, even though the transmission of the at least one uplink packet conflicts with the TFT rules 306 for the single EPS bearer.

In some example embodiments, one or more steps 502, 504, and/or 506 of flowchart 500 may not be performed. Moreover, steps in addition to or in lieu of steps 502, 504, and/or 506 may be performed. Further, in some example embodiments, one or more of steps 502, 504, and/or 506 may be performed out of order, in an alternate sequence, or partially (or completely) concurrently with other steps.

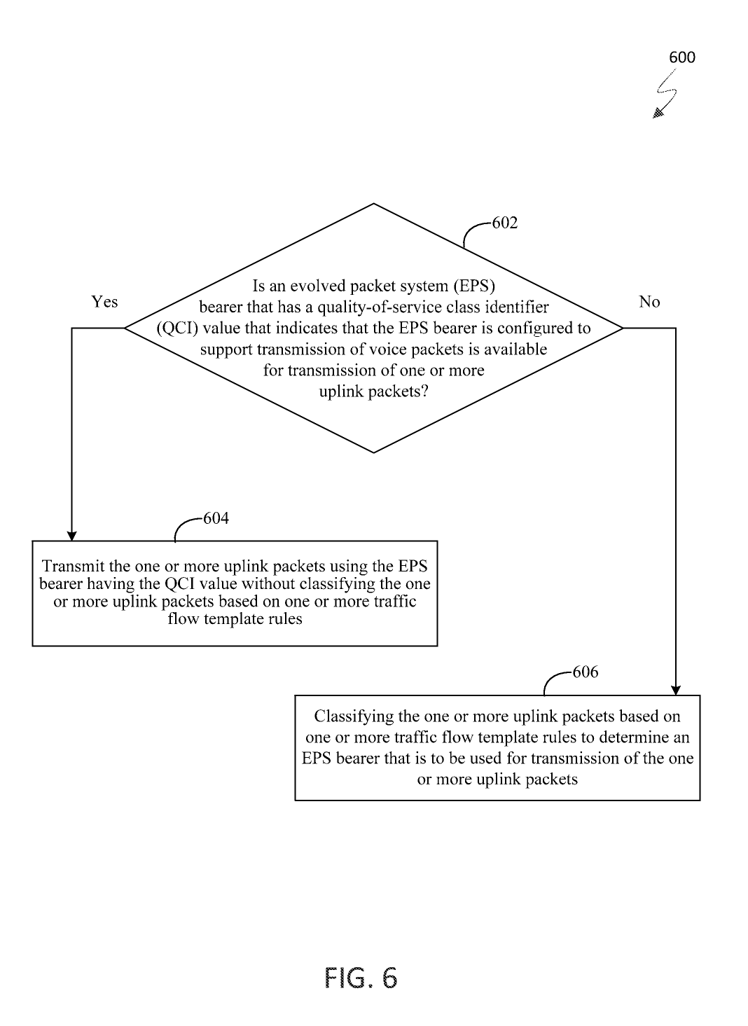

As shown in FIG. 6, the method of flowchart 600 begins with step 602. In step 602, a determination is made whether an EPS bearer that has a QCI value that indicates that the EPS bearer is configured to support transmission of voice packets is available for transmission of one or more uplink packets. In an example implementation, determination logic 128 determines whether an EPS bearer that has the QCI value is available for transmission of one or more uplink packets. If an EPS bearer that has the QCI value is available, flowchart 600 proceeds to step 604. If an EPS bearer that has the QCI value is not available, flowchart 600 proceeds to step 606.

In example embodiments, step 602 includes determining whether the EPS bearer having the QCI value is available based on, without limitation, one or more of: the QCI value of the EPS bearer being greater than or equal to respective QCI values of other EPS bearers, a determination that one or more voice packets have been transmitted using the EPS bearer that has the QCI value, and/or receiving an indication that the EPS bearer having the value has been reconfigured.

In example embodiments, step 602 is performed in response to a determination that the uplink packet(s) are voice packet(s). For example, determination logic 128 may determine that the uplink packet(s) are voice packet(s). In accordance with this example, the determination that the uplink packet(s) are voice packet(s) may be based on the uplink packet(s) being received from a voice processor, based on a source from which at least one of uplink packet(s) is received, based on a destination to which at least one of the uplink packet(s) is to be transmitted, header(s) in the uplink packet(s), etc.

In step 604, the one or more uplink packets are transmitted using the EPS bearer having the QCI value without classifying the one or more uplink packets based on one or more traffic flow template rules. In an example implementation, communication protocol logic 310 transmits the one or more uplink packets using the EPS bearer having the QCI value, even though the transmission of the one or more uplink packets conflicts with TFT rules 306 for the EPS bearer having the QCI value.

In step 606, the one or more uplink packets are classified based on one or more traffic flow template rules to determine an EPS bearer that is to be used for transmission of the one or more uplink packets. In an example implementation, when an EPS bearer that has the QCI value is not available, classifier 304 classifies the one or more uplink packets according to TFT rules 306 associated with another EPS bearer that is capable of transmitting voice packets.

In some example embodiments, one or more steps 602, 604, and/or 606 of flowchart 600 may not be performed. Moreover, steps in addition to or in lieu of steps 602, 604, and/or 606 may be performed. For instance, flowchart 600 may include determining that the EPS bearer that has the QCI value is configured to support transmission of voice packets based on the QCI value being within a designated range of values. Further, in some example embodiments, one or more of steps 602, 604, and/or 606 may be performed out of order, in an alternate sequence, or partially (or completely) concurrently with other steps.

The next section describes further example embodiments and advantages. 7. Further Example Embodiments and Advantages

The embodiments described herein may be applied to the selection of bearers for uplink packet transmissions. The techniques described herein allow for the flexible selection of bearers according to available connections and configurations that are not available under the existing 3GPP specifications and currently implemented TFT rules. As would be apparent to one skilled in the relevant art(s) having the benefit of this disclosure, the techniques described herein may be applied to any suitable communication protocol and/or device. While various embodiments are exemplarily illustrated herein with communication devices and LTE and/or VoLTE communication protocols, it will be recognized that the described techniques are also applicable to other devices and protocols.

It will be recognized that the materials described in embodiments herein, their respective shapes and dimensions, their relative positions shown in the figures, are exemplary in nature. Modifications are contemplated, as would be apparent to one of skill in the relevant art(s) having the benefit of this disclosure.

It will be recognized that the systems, their respective components, and/or the techniques described herein may be implemented in hardware, software, firmware, or any combination thereof, and/or may be implemented as hardware logic/electrical circuitry. The disclosed technologies can be put into practice using software, firmware, and/or hardware implementations other than those described herein. Any software, firmware, and hardware implementations suitable for performing the functions described herein can be used, such as those described herein.

### 8. Example Computer/Processing Device Embodiments

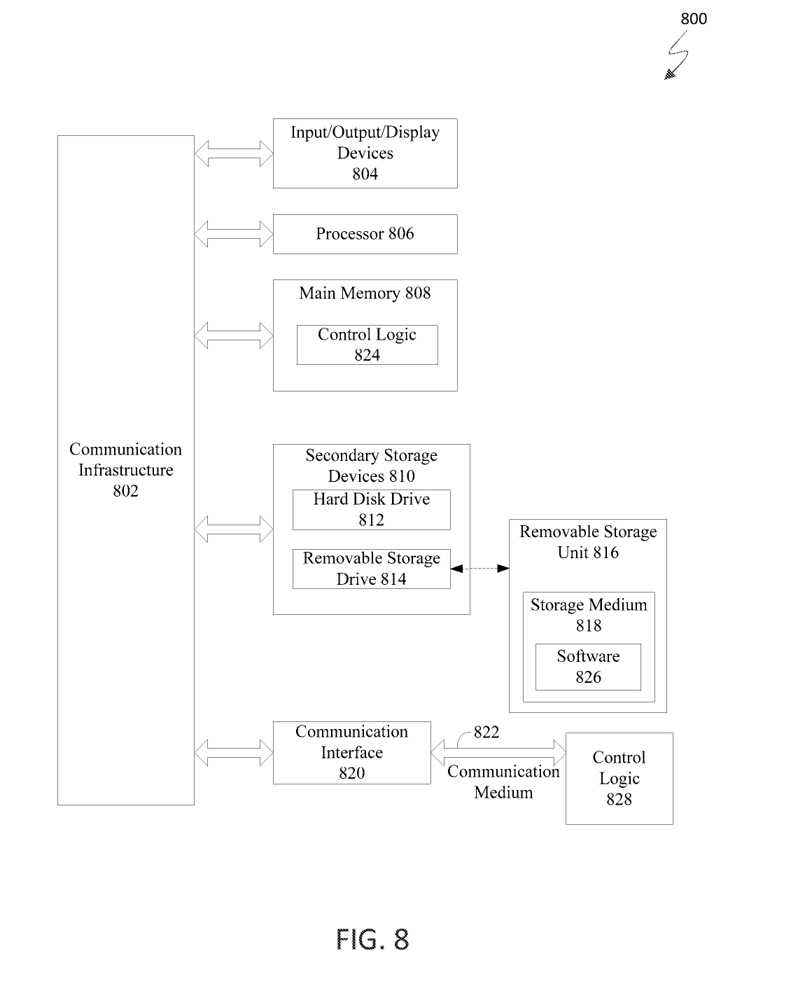

Exemplary embodiments, systems, components, subcomponents, devices, methods, flowcharts, and/or the like described herein, including but not limited to, communication system 100, communication system devices 200, communication device 300, communication device 700, flowcharts 400, 500, and 600, and/or any further systems, sub-systems, and/or components disclosed herein may be implemented in hardware (e.g., hardware logic/electrical circuitry), or any combination of hardware with software (computer program code configured to be executed in one or more processors or processing devices) and/or firmware. The embodiments described herein, including systems, methods/processes, and/or apparatuses, may be implemented using well known processing devices, telephones (smart phones and/or mobile phones), servers, and/or, computers, such as a computer 800 shown in FIG. 8. It should be noted that computer 800 may represent communication devices, processing devices, and/or traditional computers in one or more embodiments. For example, communication system devices 200, communication device 300, communication device 700, and any of the sub-systems or components respectively contained therein may be implemented using one or more computers 800.

Computer 800 can be any commercially available and well known communication device, processing device, and/or computer capable of performing the functions described herein, such as devices/computers available from International Business Machines®, Apple®, HP®, Dell®, Cray®, Samsung®, Nokia®, etc. Computer 800 may be any type of computer, including a desktop computer, a server, etc. Computer 800 includes one or more processors (also called central processing units, or CPUs), such as a processor 806. Processor 806 is connected to a communication infrastructure 802, such as a communication bus. In some embodiments, processor 806 can simultaneously operate multiple computing threads. Computer 800 also includes a primary or main memory 808, such as random access memory (RAM). Main memory 808 has stored therein control logic 824 (computer software), and data. Computer 800 also includes one or more secondary storage devices 810. Secondary storage devices 810 include, for example, a hard disk drive 812 and/or a removable storage device or drive 814, as well as other types of storage devices, such as memory cards and memory sticks. For instance, computer 800 may include an industry standard interface, such a universal serial bus (USB) interface for interfacing with devices such as a memory stick. Removable storage drive 814 represents a floppy disk drive, a magnetic tape drive, a compact disk drive, an optical storage device, tape backup, etc.

Removable storage drive 814 interacts with a removable storage unit 816. Removable storage unit 816 includes a computer useable or readable storage medium 818 having stored therein computer software 826 (control logic) and/or data. Removable storage unit 816 represents a floppy disk, magnetic tape, compact disk, DVD, optical storage disk, or any other computer data storage device. Removable storage drive 814 reads from and/or writes to removable storage unit 816 in a well-known manner. Computer 800 also includes input/output/display devices 804, such as touchscreens, LED and LCD displays, monitors, keyboards, pointing devices, etc. Computer 800 further includes a communication or network interface 818. Communication interface 820 enables computer 800 to communicate with remote devices. For example, communication interface 820 allows computer 800 to communicate over communication networks or mediums 822 (representing a form of a computer useable or readable medium), such as LANs, WANs, the Internet, etc. Network interface 820 may interface with remote sites or networks via wired or wireless connections. Control logic 828 may be transmitted to and from computer 800 via the communication medium 822.

Any apparatus or manufacture comprising a computer useable or readable medium having control logic (software) stored therein is referred to herein as a computer program product or program storage device, including but not limited to, computer 800, main memory 808, secondary storage devices 810, and removable storage unit 816. Such computer program products, having control logic stored therein that, when executed by one or more data processing devices, cause such data processing devices to operate as described herein, represent embodiments of the invention. Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic to implement, for example, embodiments, systems, components, subcomponents, devices, methods, flowcharts, and/or the like described herein (as noted above), and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

### 9. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method, comprising:
receiving a classification of an evolved packet system (EPS) bearer in accordance with a traffic flow template rule that is associated with the EPS bearer for uplink transmission of an uplink packet;
determining whether a radio bearer associated with the EPS bearer is configured to support uplink packet transmissions; and
performing an action associated with enabling the uplink transmission of the uplink packet, based on determining that the radio bearer is not configured to support uplink packet transmissions.

2. The method of claim 1, further comprising:
initiating an attempt to transmit the uplink packet using the radio bearer based on classifying the uplink packet according to the traffic flow template rule;
wherein determining whether the radio bearer is configured to support uplink packet transmissions comprises:
determining whether the radio bearer is configured to support uplink packet transmissions in response to the attempt to transmit the uplink packet using the radio bearer failing.

3. The method of claim 1, wherein performing the action comprises:
transmitting the uplink packet to one or more of a base station or a network entity on a default bearer connection.

4. The method of claim 1, wherein performing the action comprises at least one of:
tagging the traffic flow rule as invalid, or
reclassifying the uplink packet from the EPS bearer to an alternate EPS bearer and associating the uplink packet with an alternate radio bearer according to an alternate traffic flow template rule that is associated with the alternate EPS bearer.

5. The method of claim 1, wherein performing the action comprises:
receiving a communication that indicates that the radio bearer is reconfigured to provide a reconfigured radio bearer;
determining that the reconfigured radio bearer is configured to support uplink packet transmissions in response to receiving the communication; and
activating a traffic flow template rule that is associated with the EPS bearer in response to determining that the reconfigured radio bearer is configured to support uplink packet transmissions.

6. The method of claim 1, wherein performing the action comprises:
de-activating the traffic flow template rule;
receiving a communication that indicates that the radio bearer is reconfigured to provide a reconfigured radio bearer;
determining that the reconfigured radio bearer is configured to support uplink packet transmissions; and
re-activating the traffic flow template rule in response to determining that the reconfigured radio bearer is configured to support uplink packet transmissions.

7. The method of claim 1, wherein performing the action comprises:
reducing a priority of the traffic flow template rule;
receiving a communication that indicates that the radio bearer is reconfigured to provide a reconfigured radio bearer;
determining that the reconfigured radio bearer is configured to support uplink packet transmissions; and
increasing the priority of the traffic flow template rule in response to determining that the reconfigured radio bearer is configured to support uplink packet transmissions.

8. A method, comprising:
determining that at least one uplink packet is to be provided from a communication device to an access point;
determining that the access point is associated with a single bearer of a designated type, the single bearer being associated with one or more traffic flow template rules; and
transmitting the at least one uplink packet using the single bearer from the communication device to the access point irrespective of the one or more traffic flow template rules in response to determining that the access point is associated with the single bearer.

9. The method of claim 8, wherein the single bearer of the designated type is an evolved packet system (EPS) bearer.

10. The method of claim 8, wherein the single bearer of the designated type is a radio bearer.

11. The method of claim 8, wherein transmitting the at least one uplink packet using the single bearer comprises:
transmitting the at least one uplink packet without classifying the at least one uplink packet based on the one or more traffic flow template rules.

12. A method, comprising:
determining whether an evolved packet system (EPS) bearer that has a quality-of-service class identifier (QCI) value that indicates that the EPS bearer is configured to support transmission of voice packets is available for transmission of one or more uplink packets;
if an EPS bearer having the QCI value is available for transmission of one or more uplink packets, transmitting the one or more uplink packets using the EPS bearer having the QCI value without classifying the one or more uplink packets based on one or more traffic flow template rules; and
if no EPS bearer having the QCI value is available for transmission of one or more uplink packets, classifying the one or more uplink packets based on one or more traffic flow template rules to determine an EPS bearer that is to be used for transmission of the one or more uplink packets.

13. The method of claim 12, further comprising:
determining that the one or more uplink packets are one or more respective voice packets based on the one or more uplink packets being received from a voice processor;
wherein determining whether the EPS bearer that has the QCI value is available for transmission of one or more uplink packets comprises:
determining whether the EPS bearer that has the QCI value is available for transmission of one or more uplink packets in response to determining that the one or more uplink packets are one or more respective voice packets.

14. The method of claim 13, wherein determining that the one or more uplink packets are one or more respective voice packets comprises:
determining that at least one of the one or more uplink packets comprises voice data based on a source from which the at least one of one or more uplink packets is received.

15. The method of claim 13, wherein determining that the one or more uplink packets are one or more respective voice packets comprises:
determining that at least one of the one or more uplink packets comprises voice data based on a destination to which the at least one of the one or more uplink packets is to be transmitted.

16. The method of claim 13, wherein determining that the one or more uplink packets are one or more respective voice packets comprises:
identifying at least one of the one or more uplink packets as comprising voice data based on one or more packet headers in the at least one of the one or more uplink packets.

17. The method of claim 12, wherein an EPS bearer having the QCI value is available for transmission of one or more uplink packets; and
wherein the method further comprises:
selecting the EPS bearer having the QCI value from a plurality of EPS bearers based on the QCI value being greater than or equal to respective QCI values of other EPS bearers of the plurality of EPS bearers.

18. The method of claim 12, wherein determining whether the EPS bearer that has the QCI value is available for transmission of one or more uplink packets comprises:
determining that one or more voice packets have been transmitted using the EPS bearer that has the QCI value.

19. The method of claim 12, further comprising:
determining that the EPS bearer that has the QCI value is configured to support transmission of voice packets based on the QCI value being within a designated range of values.

20. The method of claim 12, further comprising:
receiving an indication that the EPS bearer that has the QCI value has been reconfigured;
wherein determining whether the EPS bearer that has the QCI value is available for transmission of one or more uplink packets comprises:
determining whether the EPS bearer that has the QCI value is available for transmission of one or more uplink packets in response to receiving the indication.
